(19) United States
(12) Patent Application Publication
(10) Pub. No.: US 2015/0243376 A1
(43) Pub. Date: Aug. 27, 2015

(54) MOLTEN SALT FISSION REACTOR

(71) Applicant: Taylor Ramon WILSON, Texarkana, AR (US)

(72) Inventor: Taylor Ramon WILSON, Texarkana, AR (US)

(21) Appl. No.: 14/632,950

(22) Filed: Feb. 26, 2015

Related U.S. Application Data
(60) Provisional application No. 61/944,824, filed on Feb. 26, 2014.

(51) Int. Cl. G21C 1/28; G21C 5/02

(52) U.S. Cl. CPC G21C 1/28; G21C 5/02

(57) ABSTRACT

A plant and a modular fission reactor including a sealed reaction module. The sealed reaction module includes a core reactor vessel filled with molten salt and fuel and a moderator and reflector positioned inside the vessel housing, the moderator and reflector forming an active region in which fission occurs. The plant may include a power module and a heat exchanger that extracts heat from the reaction module and communicates the extracted heat to the power module. A second heat exchanger may extracts heat from the first heat exchanger and communicates the heat to the power module. The core reactor vessel may comprise at least one spare fuel container coupled to the reactor vessel and/or a chemistry module coupled to the reactor vessel.

### CROSS-REFERENCE TO RELATED APPLICATION

This application claims the benefit of U.S. Application Ser. No. 61/944,824, entitled “MOLTEN SALT FISSION REACTOR” and filed on Feb. 26, 2014, which is expressly incorporated by reference herein in its entirety

### BACKGROUND

1. Field

The present disclosure relates generally to a compact, modular, and efficient apparatus for the control of and extraction of energy through nuclear processes, and more particularly to a molten salt fission reactor.

2. Background

A light water reactor (LWR) is a type of thermal reactor that uses normal water, as opposed to heavy water, as its coolant and neutron moderator. It uses a solid compound of fissile element as its fuel. Thermal reactors are the most common type of nuclear reactor, and LWRs are the most common type of thermal reactor. However, LWRs are high pressure systems, operating under a pressure on the order of 1,000 PSI. This can cause safety concerns, because there is the potential to release radioactivity when problems occur, for example, if power is lost for an extended period of time, an operator becomes incapacitated, earthquake, facility damage, etc. During such an event, the reactor is prone to expelling coolant and radioactive contents due to the high pressure and chemical reactivity (i.e. the catalytic reaction of water and hot zirconium cladding leading to hydrogen generation and combustion).

Additionally, LWRs use a solid, ceramic fuel that requires ongoing replacement. Such refueling causes additional safety and proliferation concerns, in addition to the added maintenance and disposal costs involved.

A molten salt reactor (MSR) is a class of nuclear fission reactors in which the primary coolant, or even the fuel itself, is a molten salt mixture. While LWRs typically operate at a temperature of 200-300° Celsius, and involve a high pressure core, MSRs run at higher temperatures and thus higher thermodynamic efficiency, while staying at lower pressures. While molten salt reactors reduce the pressure of the reactor core and remove the need for fuel rods, MSRs still involve safety concerns such as radiological barriers to radionuclide release and require maintenance and refueling, and have never before been successfully commercialized.

### SUMMARY

In light of the above described problems and unmet needs, aspects presented herein provide a modular, sealed reactor that provides barriers to fission material release and reduces the need for refueling and maintenance. Additional aspects provide a more robust, efficient reactor that can be manufactured in a modular fashion.

Additional advantages and novel features of these aspects will be set forth in part in the description that follows, and in part will become more apparent to those skilled in the art upon examination of the following or upon learning by practice of the invention.

### BRIEF DESCRIPTION OF THE DRAWINGS

Various example aspects of the systems and methods will be described in detail, with reference to the following figures, wherein:

FIG. 1 is a diagram illustrating an example of a reactor system in accordance with aspects of the present invention.

FIG. 2 is a diagram illustrating a cross section of an example reactor module in accordance with aspects of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

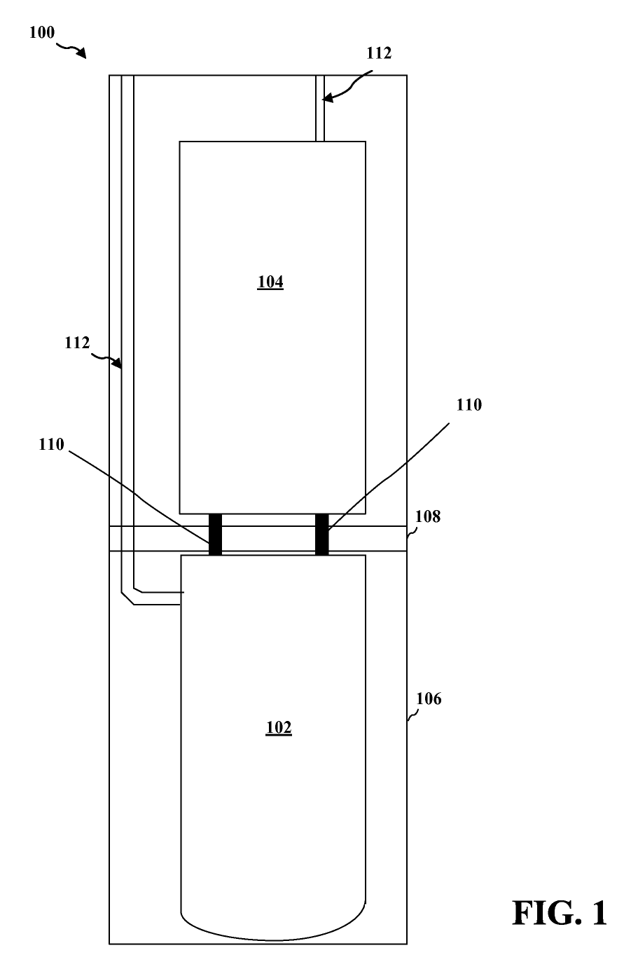

FIG. 1 illustrates an example fission reactor system 100 in accordance with aspects presented herein. System 100 includes a reactor module 102 that produces a heat output, e.g., by a fission reaction. System 100 also includes a power module 104 that extracts heat from the reactor module 102 and uses the heat to produce electricity. The power module 104 may comprise, e.g., turbomachinery. The machinery may involve a super critical carbon dioxide cycle that produces electricity from the heat of the reaction module. The power module may comprise, e.g., a compact Brayton Cycle power module for the production of electricity in a range sub-megawatt up 100 MWe. The two individual modules can be built in a factory and shipped to the site at which the reactor will be used. Then, the modules can be put together on site. Although not necessarily illustrated to scale in FIG. 1, the modules may be very similar in size. The reactor module 102 and the power module 104 may each be a transportable, factory manufactured module, the reaction module producing high grade heat and the power module utilizing the produced heat to generate electricity.

The modular units are sealed as opposed to previous MSRs that used the construction form of a more traditional LWR system.

The reaction module is fully fueled, e.g., a reactor vessel 204 is filled with fuel, to provide an up to 30 year operating life during which refueling is not required.

Once on site, the reaction module 102 and the power module 104 may be disposed in a housing 106. Housing 106 may, e.g., comprise a concrete layer sized to receive both modules. Housing 106 may be provided underground as a safety measure. A buffer layer 108 may be provided between reaction module 102 and power module 104. The buffer layer 108 may also comprise borated concrete, e.g., forming a concrete cap on the portion of the housing that receives the reaction module 102. The borated concrete cap provides for radiation shielding and physical containment. This lower chamber, unlike the upper chamber, can remain sealed for the operating life of the module. The upper chamber, e.g., and its module, e.g., the power module, is not radioactive and can be removed for maintenance.

A primary heat exchanger 110 is provided that removes heat from module 102 and transfers it to a secondary loop which does not contain fuel or fission products. The secondary loop may comprise, e.g., piping that forms a loop that extends both into the reaction module and into the power module, thereby forming a heat exchange coupling between the two modules. The primary heat exchange may comprise salt coolant disposed in the loop(s) to facilitate an exchange of energy in the form of heat between the two modules, enabling the heat generated in the reaction module to be extracted by the power module. The secondary heat exchanger, e.g., transfers heat from the secondary loop to a process loop inside power module 104 for power production, desalination, etc.

Waste heat outputs 112 and 114, e.g., piping, may facilitate the removal of waste heat from the power module 104 and reaction module 102, respectively. For example, these additional outputs may be configured as emergency outputs to a thermal reservoir above ground. Although the primary heat exchanger normally removes the heat from the reactor, these waste heat outputs form a secondary as well as an emergency heat exchanger that can passively extract heat to cool down the reactor in the event of an accident. This passive heat rejection uses natural circulation to reject heat to the surface, without the need for electricity or human intervention.

### Reaction Module

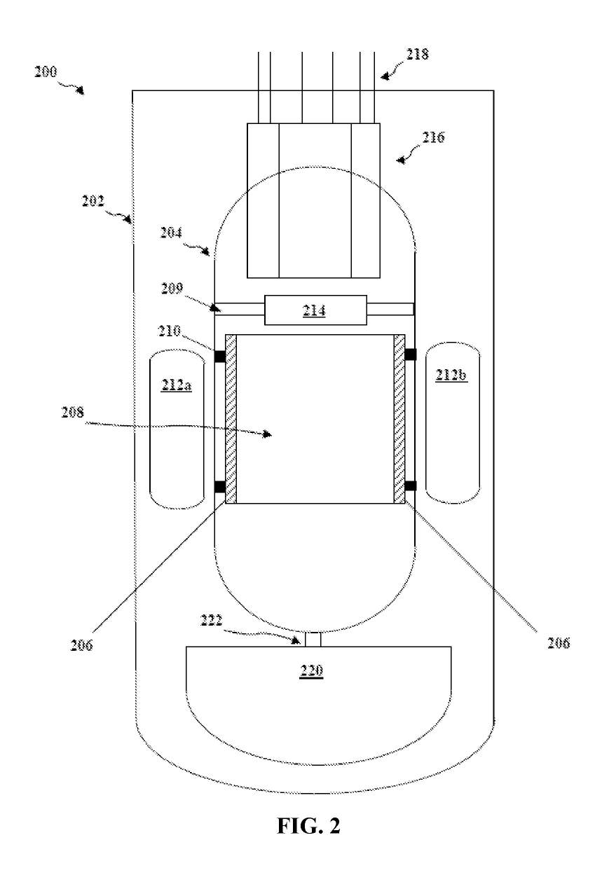

FIG. 2 illustrates aspects of an example reaction module 200. Reaction module 200 may be, e.g., reaction module 102 in FIG. 1. The reaction module 200 comprises an outer housing 202 surrounding a reactor vessel 204. The outer housing may comprise, e.g., steel. The reactor vessel is also referred to herein interchangeably as the “reaction vessel”, the “core reactor vessel”, and the “core reaction vessel.” The reactor vessel is unpressurized under an inert and controlled atmosphere, with the interior pressure can be on the order of approximately 1 atmosphere. The core reactor vessel 204 may be sized to fill approximately ¾ of the diameter of the reaction module housing 202, with the remaining ¼ being used to house subsystems that surround the reactor vessel 204.

Fuel salts and coolant or heat exchange salts are used in the reactor. The coolant salts and the fuel salts are in a liquid form at operating temperature. For example, the molten salt may comprise a mixture of ionic halides such as fluoride salts, and the fuel may comprise Uranium Fluorides (or other actinide fluoride fuels).

The molten salt fuel within the reactor vessel 204 is corrosive. Therefore, the reactor vessel 204 comprises a material that can withstand the corrosive effects of the fuel. Among others, the reactor vessel 204 material may comprise a supernickel alloy, a Hastelloy®, or other high performance alloy. The reactor vessel 204 may also comprise a stainless steel vessel coated with such an alloy.

The reactor vessel 204 may be, e.g., capsule shaped, as illustrated in FIG. 2. The reactor vessel is not pressurized, and operates substantially at atmospheric pressure.

### Material Protection System

Whether comprising stainless steel or a high performance alloy, the reactor vessel 104 may comprise a material protection system (MPS). The MPS may comprise a protective layer lining an interior of the reactor vessel, the protective layer comprising, e.g., any of graphite, coated ceramic materials, and a combination or composite thereof. Thus, when the reactor vessel comprises stainless steel, the reactor vessel may be lined with a high performance alloy and with the MPS.

### Moderator/Reflector

A moderator/reflector 206 is provided in the interior of the reactor vessel 204. The moderator/reflector defines an active region 208 within the reactor vessel 204. A cross section of a moderator/reflector 206 is shown in FIG. 2. The moderator and/or reflector 206 may comprise, e.g., graphite, beryllium oxide, metal hydrides, and any combination thereof. The moderator may be shaped as a cylinder of graphite, beryllium oxide, metal hydride, combinations thereof, etc. Coatings may be applied to the moderator to improve material compatibility and extend useful life. Although the moderator and reflector can comprise similar materials, the reflector is configured as a barrel outside of the moderator, e.g., surrounding the moderator. Sustained nuclear reactions cannot occur within the reactor vessel 204 exterior to the moderator/reflector 206. This forms an “active region” within the reactor.

The fission reaction occurs only within the active region 208 of the reactor vessel rather than within the entire interior of the reactor vessel 204. Within this active region, fission reactions are allowed to sustain via a combination of moderation and reflection of low energy neutrons, i.e., provided by the moderator/reflector. The active region involves a combination of neutron moderation and reflection that allows a sustained chain reaction. This sustained chain reaction can only occur within the interior of the cylindrical moderator component 208. Thus, the active region may comprise only a fraction of the core reactor vessel, e.g., only about one third of the interior of the reactor vessel 204. While the active region provided interior to the moderator may comprise only a third of the volume of the reactor vessel 204, the moderator itself may fill approximately ¾ of the volume of the reactor vessel 204. The remainder of the reactor vessel, while it may contain fissionable fuel, does not have the proper geometry for fission reaction propagation. The active region is the region in which heat is generated, introduced to the coolant, and where the control of the fission reaction is made.

Mounting components 210 mount the moderator 206 to the interior of the reactor vessel 204 such that the moderator is spaced from an inner wall of the reactor vessel 204.

### Circulation

A natural circulation occurs within the reactor vessel 204. Molten salt has a high thermal expansion coefficient. Therefore, salt within the active region, which is heated by the fission reaction, rises to an upper portion of the reactor vessel 204, where heat is extracted from the molten salt via the heat exchanger. In contrast to heat extraction via coolant loops that exit from the primary vessel to external heat exchangers, the primary heat exchanger of this design may be annular, and fit inside the reactor vessel, where heat is extracted from the top of the pool of coolant. The coolant salt, having a high thermal expansion coefficient, becomes denser and moves with a tendency back towards the bottom of the reactor vessel 204 and is replaced by salt that has been heated within the active region. As the cooled salt moves toward the bottom of the reactor vessel, it passes through the “active region” in the core, where nuclear reactions are taking place. Passing through the active region introduces heat to the coolant salt causing it to become less dense and to circulate back to the top of the vessel to repeat the process. Thus, a natural flow circulates the hot salt up to the heat exchanger where the heat can be extracted and brings the cooler salt back down through the active region where it is heated. This natural circulation forms the primary driver of flow inside the reactor vessel 204.

The natural circulation effect in the core reactor vessel removes the need to include a pump to circulate the material through the core reaction vessel, because the thermal expansion in the salt does it naturally. Pumps internal to the core reaction vessel can be a source of problems. Therefore, the natural circulation effect removes a source of safety problems or a potential source of maintenance needs. In one example pumping may be provided to supplement this natural circulation effect. Also, even if no pump is used to circulate the materials within the reactor vessel, at least one pump may be provided in the heat exchangers.

### Chemistry Module

In order to provide for the important features of online refueling when using liquid fuel, gaseous and volatile Fission Product extraction, and corrosion control and redox potential control, a chemistry module 214 may be provided inside the reactor vessel 204. This chemistry make-up box 214 may be connected to a chemistry circuit which also includes fuel reservoirs, traps for gaseous Fluorine and HF, and traps for a Fission Products. The chemistry module may be coupled to the reactor vessel 204 via piping 216.

In uranium fission reactions, a collection of poisons is produced. The poisons build up, thereby preventing the use of the current fuel for continued nuclear reactions. The poisons comprise, e.g., fission byproducts as the uranium is fissioned. In traditional nuclear engineering, this is referred to as the xenon pit. The fuel is not necessarily depleted, but the presence of the poison reduces the ability of the fuel to perform the desired nuclear reactions. In order to provide a 30 year operating life for the reactor, the poisons need to be extracted. With current nuclear plants using solid ceramic pellets of fuel, there is no way to extract the poison without physically removing the fuel from the reactor. Thus, the fuel must be periodically removed and replaced. For example, every 18 months, the fuel may need to be replaced.

Aspects presented herein, provide a way to separate the poison from the material inside the core reaction vessel 204 while maintaining the sealed status of the reaction module 102.

For safety and security, aspects presented herein include a completely fueled system that does not require the addition of fuel or the physical removal of poisons out of the reaction module. Thus, the chemistry module 214 may be coupled to the reactor vessel and provided internal to the reaction module. The chemistry module provides minimal online processing that allows it to remove the poisons, e.g., xenon, iodine, krypton, etc., from the core reactor vessel 204. This minimal processing is done inside of the reaction module, and may involve any of gas sparging, chemical adsorption and absorption, and/or chemical reactions. Additionally less volatile Fission Products may be removed by providing sacrificial high surface area traps in the chemistry module.

### Fuel Reservoir

In addition to material choices and a chemistry make-up box, an additional feature is included in order to provide a long sealed operating life for the reactor: at least one additional fuel reservoir, e.g., fuel reservoir, 212a, 212b may be located inside the reaction module 200. These fuel reservoirs are filled just as the reactor vessel is fueled from cylinders of, e.g., uranium hexafluoride UF6 at initial fueling. These reservoirs are a connected to the chemistry circuit and to the core via the chemistry make-up box.

The fuel reservoirs are coupled to the reactor vessel so that additional fuel may be added to the reactor vessel over the life of the reactor. For example, small amounts of fuel may be continuously added over the life of the reactor to compensate for fuel burn up.

These fuel reservoirs can be shipped as a component of the modular reactor. The reaction module and the power module both use a coolant salt. The coolant salt may be added at the time of manufacturing the modular components. The salt may comprise, e.g., a mixture of lithium, sodium, and beryllium fluoride. These modular components can be filled with the salt mixture and shipped after manufacture.

At the site, UF6 can be added to the core reactor vessel and to the fuel reservoirs. The standard cylinder of UF6 can essentially be hooked up to the modules. Through a chemical process, the material is converted to a molten salt inside of the reactor. Thus, the spare fuel tanks 212a, 212b, hold additional UF6 that can be added to the reactor vessel. This provides a completely fueled system that does not require external refueling once nuclear reactions begin. Thus, once completely fueled, the reactor generates power for approximately up to 30 years without requiring any external input or output.

The reactor modules can be fueled by either liquid fuels or solid fuel compacts. These compacts, e.g., composed of coated spherical fuel particles (including the fuel commonly known as TRISO particles) dispersed in a matrix provide many of the same safety features as the liquid fueled variants, specifically containing radionuclides in the event of an excursion, loss of coolant, or other reactor accident. In one example, the solid fuel may comprise graphite compacts containing coated fuel particles.

The use of solid fuel relies on the same general subsystems and design, but without considerations for fueling and coolant radiochemistry systems, and may incorporate burnable poisons to control for reductions in core reactivity that mimics the online refueling provided in liquid fueled variants.

### Heat Exchanger

A heat exchanger extends into the reactor vessel, also referred to herein as the “primary heat exchanger.” The heat exchanger is positioned above the active region 208. Thus, the heat exchanger extracts heat from an upper portion of the reactor vessel 204. The heat exchanger comprises a first heat exchanger component 216 and a second heat exchange component 218.

The first heat exchange component 216 may comprise, e.g., an annular design that is provided above the active region to extract heat from the reactor vessel 204. The first heat exchange component may comprise, e.g., a first loop filled with molten salt, and the second heat exchange component may comprise a second loop filled with molten salt. The first loop of molten salt is provided interior to the reaction module 200. The first heat exchanger loop sits in the molten salt of the reactor vessel 204 and exchanges the heat from the primary salt bath of the reactor vessel 204 to the secondary salt loop of the second heat exchanger 218. For example, a loop formed by the second heat exchanger component 218 is shown as 110 in FIG. 1, extending between the reaction module 102 and the power module 104. The only access point into the filled reactor module 200 is the non-radioactive secondary salt loop. Both salt loops are non-pressurized and operate substantially at atmospheric pressure.

The second heat exchange component is provided external to the reactor vessel 204 and connects between the reaction module 200 and the power module, e.g., 104. This second heat exchange component 218 is sealed and the coolant salts within the component are not exposed to the radioactive material inside of the reactor vessel 204. Thus, while the second loop is thermally hot and contains molten salt, it is not radioactive. Radioactive material does not enter the power module 104.

The power module 104 may further comprise, e.g., a third loop of super critical carbon dioxide or other working fluid. This is a power cycle, and is under pressure. This loop of gas may then expand through a turbine which produces the electricity before being cooled and recompressed in a standard Brayton power cycle.

At least a portion of the first heat exchange component 216 extends into the molten salt fuel inside the reactor vessel 204. This portion extracts heat from the molten salt fuel and communicates that extracted heat to the second heat exchanger component 218 which communicates the extracted heat to a power module, e.g., 104 from FIG. 1. Each heat exchange component may comprise a heat exchange material, such as a molten salt. The heat exchange components may also include a pump to actively circulates the coolant salt material through loops of the component, as opposed to the passive circulation of the molten salt in the core reactor vessel itself.

This provides a fundamental safety improvement that prevents the potential for fission product release. The fuel salts and the coolant salts in the first heat exchanger are completely contained in the reaction module 200. No loops of the first heat exchange 216 coolant or reaction fuel ever exit this structure.

Both the primary and secondary loops of the heat exchanger can be un-pressurized. Thus, there is no pressure in the reaction module, as the secondary loop that connects between the reaction module 102 and the power module 104 are not under pressure. The molten salt material comprised in the primary 216 and secondary 218 loops of the heat exchanger may be the same salt material used to fill the reactor vessel 204, e.g., a mixture of lithium and beryllium fluoride. At least one loop may also use a different chemistry, such as a different fluoride salt mixture or nitrate/nitrate eutectic.

In addition to the primary heat exchanger inside the reactor module, a backup primary heat exchanger may be provided internal to the annular primary heat exchanger. This back up heat exchanger provides emergency heat rejection in case of an emergency involving loss of power or failure of the primary heat transfer route. For example, this back up heat exchanger and corresponding thermal loop may have a lower capacity for heat transfer and may safely reject decay heat after a reactor SCRAM. The backup primary heat exchanger can reject heat to a thermal loop using natural circulation for heat rejection to the environment.

Among other materials, the heat exchangers can be constructed from a high performance metal alloy or from a ceramic composite material such as Carbon/Silicon Carbide, or a combination of both. Among constructions, the heat exchangers may use printed channels as opposed to a traditional tube-in-shell construction to ensure the compact design.

### Dump Tank

A dump tank 220 may be coupled to reactor vessel 204 at a position that allows the reactor fuel to drain into the dump tank if a problem were to occur with the reactor. This provides an additional safety margin in the occurrence of serious events that cause extended loss of power, facility damage, etc. For example, if any aspect of the reaction becomes uncontrollable due to such an event, the entire molten salt mixture that fills the reactor vessel 204 can be passively drained into the dump tank. Dump tank 220 may be coupled, e.g., via connection 222. For example, with a molten salt fuel, by providing the dump tank below the reactor vessel, the fuel is able to passively drain into the dump tank simply using gravity. By removing the fuel from the reactor vessel 204, the reaction ceases. Additionally, the dump tank may include passive cooling to remove decay heat and ceramic neutron absorbers (such as Boron Carbide (B4C) placed in the dump tank to further ensure that any nuclear reactions cease. Thus, once the molten salt contents of the reactor vessel 204 are drained into the dump tank 220, the nuclear reactions cannot continue and the material is passively cooled.

Connections 110, 112, 209, 216, 218, and 222 may be formed as a passage, piping, conduit, etc.

### Modularity

The reaction module may be manufactured as a compact, filled module that does not require external refueling over the life span of the reaction module.

The reactor module and process module, as well as additional necessary equipment, such as that for power distribution and construction of a heat sink, are transported to the plant site preassembled and connected. The reactor module is shipped to the site with coolant salts preloaded in the reactor vessel, however the reactor is not fueled for transport. When the plant is ready for operation, uranium fluoride UF6 fuel is added to the core and additional fuel reservoirs from standard transport cylinders of UF6 shipped to the site separately. This UF6 is added in either a liquid or gas phase to the reactor's chemistry circuit.

### Safe

Reactors operating under high pressure in their cores are prone to expelling dangerous contents in the event of an earthquake or loss of site power or operators. The reactor presented herein operates at a primary loop pressure approximately 1 atmosphere, e.g., at essentially atmospheric pressure. Therefore, when problems occur, such as loss of power, natural disasters, operator failure, etc., there is no chemical or hydraulic reactivity inside of the reactor that would cause the reactor to expel its contents. There is no pressure causing the hazardous contents of the core to exit the reactor. At atmospheric pressure, the contents have an inclination to remain within the core.

As the materials exposed to the fission reaction never leave the reaction vessel, e.g. due to the design of the heat exchanger, there is no potential to release radioactivity in that manner. Additionally, by using a liquid fuel, in the event of a problem, the liquid fuel can be passively drained into the dump, whereas solid fuel cannot be passively removed from reaction region. Thermal expansion of the salt may be designed to provide fast negative reactivity with increased temperatures.

### Scalability

The modular aspects of the design allow it to be scaled to provide power at different scales. For example, the size of the modular aspects of the reactor may be sized to output an amount of power for a desired application. For example, the reactor components may be selected or sized in order to output any amount between approximately 1 MW and 100 MW of electric power. Although the reactor is capable of being scaled to produce power above 100 MW, beyond approximately 100 MW, the reactor might not be the most efficient choice of reactor. In the range of 2 to 100 MW, the aspects presented herein provide an efficient, safe source of power.

In one example illustration, the reactor may be sized in order to generate power on the order of approximately eight MW. This can replace diesel generators that require a continual supply of expensive fuel. In another example, illustration, the reactor components may be sized to generate power on the order of approximately 50 MW. This can provide sufficient power for a region. This allows that region to be independent of a distributed power system, and reduces the need for building large GW power plants. Instead, each power region can have its own 50 MW power production center. One of the problems associated with a distributed power system is the losses that occur in transmission lines that transmit the power from these large power plants to distant regions. Due to the distances involved, the system is inefficient and susceptible to breakdowns. For example, such a distributed system can be vulnerable to terrorist attacks, hurricanes, and other natural disasters.

As an additional example, the reactor components can be sized to output power on the order of approximately 100 MW. This power output can provide power for utilities for a large urban area. For each of these different levels of power output, the reactor design is the same, the difference being the scale of the components.

As one example, the reactor module could be approximately 2.5 meters in diameter. This size of reactor vessel generates power on the order of approximately 1/10 of the output of a standard nuclear power reactor.

Traditional molten salt reactors were designed for large multi-GW operation. In contrast, the reactor present herein is very compact and can be scaled to lower power applications. Additionally, the system can function as a fully fueled system that runs for approximately 30 years without any refueling or maintenance.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art, and the generic principles defined herein may be applied to other aspects. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A modular fission reactor comprising:
a sealed reaction module, wherein the reaction module is fully fueled, the reaction module comprising:
a reactor vessel;
at least one spare fuel container coupled to the reactor vessel; and
a chemistry module coupled to the reactor vessel.

2. The reactor of claim 1, wherein the spare fuel tank is configured to continuously release fuel into the reactor vessel.

3. The reactor of claim 1, wherein the chemistry module comprises:
a chemistry make up box; and
a chemistry circuit including:
at least one fuel reservoir;
at least one trap for gaseous Fluorine and HF; and
at least one trap for fission products.

4. A core reactor vessel comprising:
a vessel housing;
molten salt;
fuel; and
a moderator and reflector positioned inside the vessel housing, the moderator and reflector forming an active region, wherein nuclear reactions involving the fuel occur only within the active region.

5. The core reactor vessel of claim 4, wherein the molten salt comprises a mixture of at least one selected from a group consisting of fluoride salts and other ionic halides, and
wherein the fuel comprises at least one selected from a group consisting of Uranium Fluorides and other actinide fluoride fuels.

6. The core reactor vessel of claim 4, wherein the moderator comprises at least one selected from a group consisting of graphite, beryllium oxide, hydrides, and any combination thereof.

7. The core reactor vessel of claim 6, wherein the moderator comprises a cylinder of graphite, beryllium oxide, and any combination thereof.

8. The core reactor vessel of claim 4, wherein a natural circulation of molten salt occurs within the core reactor vessel during operation.

9. The core reactor vessel of claim 4, wherein the fuel comprises a solid fuel.

10. A core reactor vessel comprising:
a vessel housing configured to house a molten salt and fuel combination, the vessel housing including a protective layer lining an interior of the vessel housing, the protective layer comprising at least one selected from a group consisting of graphite, coated ceramic materials, and a combination thereof.

11. The core reactor vessel, wherein the vessel housing comprises at least one selected from a group consisting of a high performance alloy, a supernickel alloy, and a Hastelloy®.

12. The core reactor vessel of claim 10, wherein the vessel housing comprises stainless steel and a high performance alloy layer provided between the stainless steel and the protective layer.

13. A reactor comprising:
a reaction module including a core reactor vessel; and
a power module
a first heat exchanger disposed entirely internal to the reaction module, the first heat exchanger extracting heat from the core reactor vessel; and
a second heat exchanger that extracts heat from the first heat exchanger and communicates the heat to the power module.

14. The reactor according to claim 13, wherein the first heat exchanger comprises at least one annular loop filled with a coolant salt, the annular loop extending into the core reaction vessel.

15. The reactor according to claim 14, wherein the second heat exchanger comprises a second loop filled with a coolant salt, wherein the reactor is configured so that the second loop does not come into contact with reaction materials.

16. A plant comprising:
a sealed reaction module including:
a core reactor vessel filled with molten salt and fuel; and
a moderator and reflector positioned inside the vessel housing, the moderator and reflector forming an active region in which fission occurs;
a power module; and
a heat exchanger that extracts heat from the reaction module and communicates the extracted heat to the power module.

17. The plant of claim 16, wherein the sealed reaction module further includes:
at least one spare fuel container coupled to the reactor vessel, wherein the spare fuel container is configured to continuously release fuel into the reactor vessel; and
a chemistry module coupled to the reactor vessel.

18. The plant of claim 17, wherein the chemistry module comprises:
a chemistry make up box; and
a chemistry circuit including:
at least one fuel reservoir;
at least one trap for gaseous Fluorine and HF; and
at least one trap for fission products.

19. The plant of claim 16, wherein the moderator comprises a cylinder comprising at least one selected from a group consisting of graphite, beryllium oxide, and any combination thereof.

20. The plant of claim 16, wherein the core vessel reactor comprises a vessel housing to house the molten salt and fuel combination, the vessel housing including a protective layer lining an interior of the vessel housing, the protective layer comprising at least one selected from a group consisting of graphite, coated ceramic materials, and a combination thereof.

21. The plant of claim 16, wherein the heat exchanger comprises:
a first heat exchanger loop disposed entirely internal to the reaction module, the first heat exchanger extracting heat from the core reactor vessel; and
a second heat exchanger loop that extends between the reaction module and the power module, wherein the second heat exchanger loop extracts heat from the first heat exchanger and communicates the heat to the power module.
